(19) United States
(12) Patent Application Publication
(10) Pub. No.: US 2024/0069891 A1
(43) Pub. Date: Feb. 29, 2024

(54) ELECTRONIC DEVICE BIOS UPDATES

(71) Applicant: Hewlett-Packard Development Company, L.P., Spring, TX (US)

(72) Inventors: Wei Ze Liu, Spring, TX (US); Rosilet Retnamoni Braduke, Spring, TX (US); Baraneedharan Anbazhagan, Spring, TX (US); Mason Gunyuzlu, Spring, TX (US)

(73) Assignee: Hewlett-Packard Development Company, L.P., Spring, TX (US)

(21) Appl. No.: 18/260,679

(22) PCT Filed: Jan. 21, 2021
(86) PCT No.: PCT/US2021/014399

§ 371 Date: Jul. 7, 2023

(51) Int. Cl. G06F 8/65; H04L 9/32

(52) U.S. Cl. CPC G06F 8/65; H04L 9/3247

(57) ABSTRACT

An example electronic device includes a storage circuit, a central processing unit (CPU) coupled to the storage circuit, and a controller coupled to the storage circuit. The CPU is to receive a Basic Input/Output System (BIOS) update image for the electronic device, verify a signature of the BIOS update image, and responsive to verification of the BIOS update image, store a portion of the BIOS update image in the storage circuit. The controller is to obtain the portion of the BIOS update image from the storage circuit, and program the portion of the BIOS update image to a BIOS component of the electronic device.

### BACKGROUND

Some computing devices include Basic Input/Output System (BIOS) executable code. The BIOS executable code may be executed at startup of the computing device to initialize and/or test components of the computing device, initialize an operating system executing on the computing device, and/or interface between the computing device and peripherals such as a keyboard, display device, storage device, and/or other input/output (I/O) devices.

### BRIEF DESCRIPTION OF THE DRAWINGS

Various examples will be described below referring to the following figures:

FIG. 1 is an electronic device having a Basic Input/Output System (BIOS) in accordance with various examples.

FIG. 2 is a flowchart of a method for BIOS updating in accordance with various examples.

FIG. 3 is a flowchart of a method for BIOS updating in accordance with various examples.

FIG. 4 is a flowchart of a method for BIOS updating in accordance with various examples.

FIG. 5 is a flowchart of a method for BIOS updating in accordance with various examples.

### DETAILED DESCRIPTION

As described above, some computing devices include Basic Input/Output System (BIOS) executable code. As used herein, a basic input/output system (BIOS) refers to hardware or hardware and instructions to initialize, control, or operate a computing device prior to execution of an operating system (OS) of the computing device. Instructions included within a BIOS may be software, firmware, microcode, or other programming that defines or controls functionality or operation of a BIOS. In one example, a BIOS may be implemented using instructions, such as platform firmware of a computing device, executable by a processor. A BIOS may operate or execute prior to the execution of the OS of a computing device. A BIOS may initialize, control, or operate components such as hardware components of a computing device and may load or boot the OS of computing device.

In some examples, a BIOS may provide or establish an interface between hardware devices or platform firmware of the computing device and an OS of the computing device, via which the OS of the computing device may control or operate hardware devices or platform firmware of the computing device. In some examples, a BIOS may implement the Unified Extensible Firmware Interface (UEFI) specification or another specification or standard for initializing, controlling, or operating a computing device.

The BIOS executable code may be executed at startup of the computing device to initialize and/or test components of the computing device, initialize an operating system executing on the computing device, and/or interface between the computing device and peripherals such as a keyboard, display device, storage device, and/or other input/output (I/O) devices. Sometimes, updates may become available for the BIOS code and it may be useful to implement these updates to provide increased performance, increased security, etc. In some examples, the BIOS may be for, or associated with, a central processing unit (CPU) of the computing device. The CPU may be a component of the computing device that handles a majority of processing functionality for the computing device. In some examples, normal processing of the CPU (e.g., such as user tasks) may be interrupted to enable the CPU to update the BIOS during the interrupted period during which the normal processing of the CPU is not performed. However, interrupting the normal processing of the CPU for an extended time sufficient for the CPU to update the BIOS may degrade a user experience of the computing device and/or cause the computing device (such as an operating system executed by the CPU) to crash, sometimes resulting in a reboot and/or reset of the computing device.

This disclosure describes a device that includes an embedded controller for updating a BIOS of the device. In some examples, a CPU of the device may execute an operating system that includes a BIOS update tool. The BIOS update tool may cause the CPU to receive and verify a BIOS update. Following verification of the BIOS update, the CPU may transmit the BOIS update to the embedded controller in multiple portions via a shared memory accessible by both the CPU and the embedded controller. In some examples, the portions may be smaller than an entire size of the BIOS updates, such as portions that are about 4 kilobytes (kb) in size. The embedded controller may program the portion of the BIOS update to a component that stores the BIOS of the device. By transmitting the BIOS update to the embedded controller in portions that are small in size, and the embedded controller programming the component that stores the BIOS of the device, an amount of consecutive time dedicated by the CPU to the BIOS update may be reduced. Thus, rather than interrupting normal processing of the CPU to transmit an entirety of the BIOS update to the embedded controller at one time, the CPU may transmit the portions of the BIOS update. Similarly, rather than interrupting normal processing of the CPU to program the component that stores the BIOS of the device, the CPU may continue normal processing while the embedded controller programs the component that stores the BIOS of the device. In these ways, an amount of time for which normal processing of the CPU is interrupted may be reduced, thereby increasing a quality of a user experience of the device while updating the BIOS.

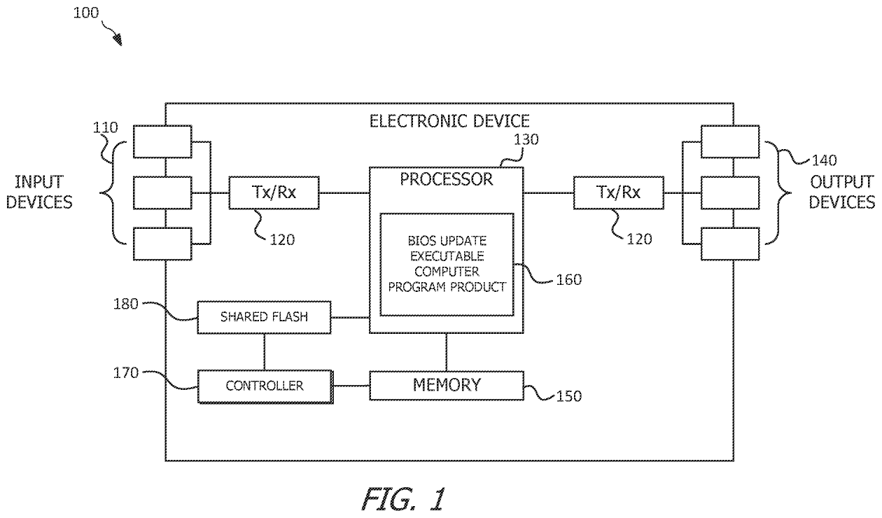

FIG. 1 is a block diagram depicting an example of an electronic device 100. Electronic device 100 may be any suitable computing or processing device capable of performing the functions disclosed herein such as a computer system, a laptop (or similar) device, a tablet device, a smartphone, a personal computer, a server, an Internet of Things device, a cloud computing node, etc. Electronic device 100 may implement some of the features/methods disclosed herein, for example, as described below with respect to any of the method 200, method 300, method 400, and/or method 500.

The electronic device 100 may comprise input devices 110. Some of the input devices 110 may be microphones, keyboards, touchscreens, buttons, toggle switches, cameras, sensors, and/or other devices that allow a user to interact with, and provide input to, the electronic device 100. Some of the input devices 110 may be downstream ports coupled to a transceiver (Tx/Rx) 120, which may be transmitters, receivers, or combinations thereof. The Tx/Rx 120 may transmit and/or receive data to and/or from other computing devices via some of the input devices 110. Similarly, the electronic device 100 may comprise a plurality of output devices 140. Some of the output devices 140 may be speakers, a display screen (which may also be an input device such as a touchscreen), lights, or any other device that allows a user to interact with, and receive output from, the electronic device 100. At least some of the output devices 140 may be upstream ports coupled to another Tx/Rx 120, wherein the Tx/Rx 120 may transmit and/or receive data from other nodes via the upstream ports. The downstream ports and/or the upstream ports may include electrical and/or optical transmitting and/or receiving components. In another example, the electronic device 100 may comprise antennas (not shown) coupled to the Tx/Rx 120. The Tx/Rx 120 may transmit and/or receive data from other computing or storage devices wirelessly via the antennas. In yet other examples, the electronic device 100 may include additional Tx/Rx 120 such that the electronic device 100 may have multiple networking or communication interfaces, for example, such that the electronic device 100 may communicate with a first device using a first communication interface (e.g., such as via the Internet) and may communicate with a second device using a second communication interface (e.g., such as another electronic device 100 without using the Internet).

A processor 130 may be coupled to the Tx/Rx 120 and some of the input devices 110 and/or output devices 140 and may implement the BIOS update described herein, such as via a BIOS update executable computer program product 160. In an example, the processor 130 may comprise multi-core processors and/or memory modules 150, which function as data stores, buffers, etc. The processor 130 may be implemented as a general processor or as part of application specific integrated circuits (ASICs), field-programmable gate arrays (FPGAs), and/or digital signal processors (DSPs). Although illustrated as a single processor, the processor 130 is not so limited and may comprise multiple processors. In some examples, the processor 130 may be, or may be referred to as, a CPU.

FIG. 1 also illustrates that a memory module 150 may be coupled to the processor 130 and may be a non-transitory medium to store various types of data. The term “non-transitory” does not encompass transitory propagating signals. Memory module 150 may comprise memory devices including secondary storage, read-only memory (ROM), and random-access memory (RAM). The secondary storage may comprise of disk drives, optical drives, solid-state drives (SSDs), and/or tape drives and may be used for non-volatile storage of data and as an over-flow storage device if the RAM is not large enough to hold all working data. The secondary storage may be used to store programs that are loaded into the RAM when such programs are selected for execution. The ROM may be used to store instructions and/or data that are read during program execution. The ROM may be a non-volatile memory device that may have a small memory capacity relative to the larger memory capacity of the secondary storage. The RAM may be used to store volatile data and perhaps to store instructions. Access to both the ROM and RAM may be faster than to the secondary storage.

The memory module 150 may be used to house the instructions for carrying out the various examples described herein. For example, the memory module 150 may comprise the BIOS update executable computer program product 160, which may be executed by processor 130.

By programming and/or loading executable instructions onto the electronic device 100, one of the processor 130 and/or the memory module 150 may be changed, transforming the electronic device 100 in part into a particular machine or apparatus, for example, a dock health monitoring device having the novel functionality taught by the present disclosure.

In some examples, the electronic device 100 may also include a controller 170 and a shared flash memory 180. The controller 170 may be, for example, an embedded controller in communication with the processor 130. The shared flash memory 180 may be, for example, a serial peripheral interface (SPI) based flash memory component that stores a BIOS for the processor 130 and provides the BIOS to the processor 130, such as at startup of the processor 130 and/or the electronic device 100. The controller 170 may share access to the memory module 150 with the processor 130. In some examples, the controller 170 may include a memory (not shown) that stores executable code or instructions for execution by the controller 170.

In some examples, the BIOS update executable computer program product 160 may include executable instructions to cause the electronic device 100 to implement a BIOS update tool. The BIOS update tool, in some examples, may facilitate updating a BIOS of the processor 130. For example, the BIOS update tool may cause the processor 130 to obtain and verify a signature of a BIOS update. The BIOS update may be obtained, in some examples, in multiple portions that are each smaller in size than a total size of the BIOS update. The BIOS update may be obtained by the processor 130, in some examples, from a storage location, such as a non-secure storage location, to which the BIOS update tool downloaded and stored the BIOS update. After obtaining a last portion of the BIOS update and verifying the signature of the BIOS update, the BIOS update tool may cause the processor 130 to provide the BIOS update to the controller 170. For example, the processor 130 may write the BIOS update to a portion of the memory module 150 that is shared between the processor 130 and the controller 170. The processor 130 may write the BIOS update to the memory module 150 in multiple portions that are each smaller in size than a total size of the BIOS update. The controller 170 may write or program each portion of the BIOS update written to the memory module 150 by the processor 130 to the shared flash memory 180. In some examples, the processor 130 and the controller 170 may each operate in respective execution loops to update the BIOS of the processor 130, as stored in the shared flash memory 180, until the BIOS of the processor 130 stored in the shared flash memory 180 has been fully updated according to the BIOS update.

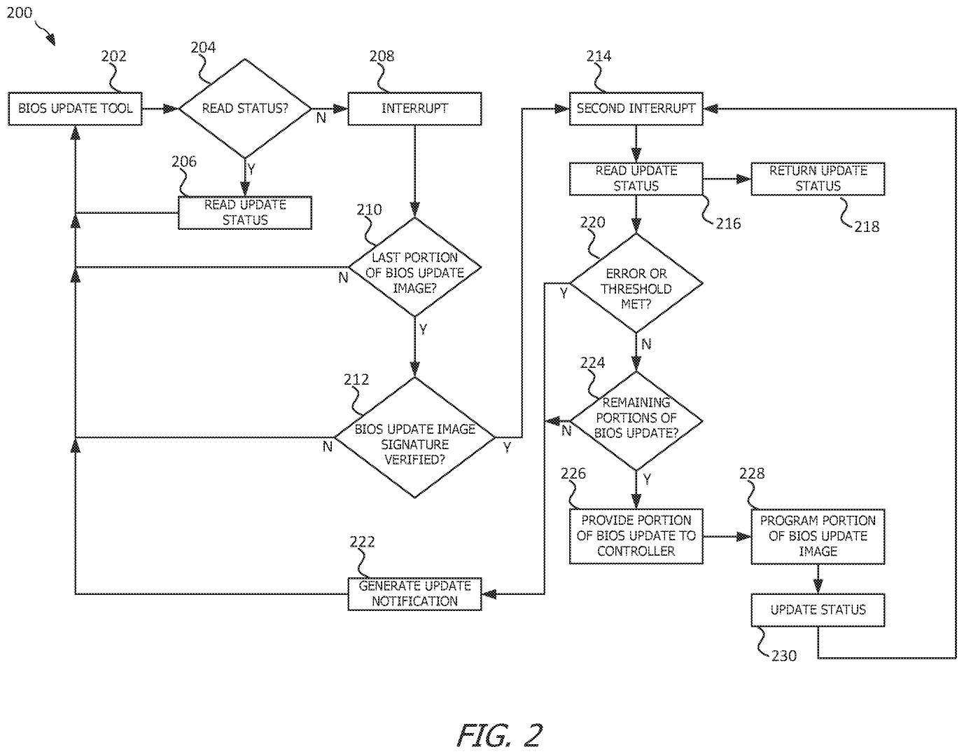

FIG. 2 is a flowchart of an example method 200 for BIOS updating. In some examples, the method 200 may be suitable for implementation on an electronic device, such as the electronic device 100 of FIG. 1. For example, in some implementations the method 200 may be partially embodied as the BIOS update executable computer program product 160 and may be performed in part by the processor 130 and in part by the controller 170. Accordingly, the method 200 may be implemented in part as computer-executable instructions or code, stored on a computer-readable medium, such as the memory module 150 of FIG. 1, which, when executed by a processor, such as the processor 130 of FIG. 1, may cause the processor 130 to execute the computer-executable instructions to perform operations. For example, the processor 130 may execute the computer-executable instructions to implement or execute a BIOS update tool. The method 200 may be implemented by the electronic device 100, in some examples, to update a BIOS of the processor 130.

At operation 202, the BIOS update tool may execute to begin operation of the BIOS updating of the electronic device 100. In some examples, execution of the BIOS update tool includes downloading a BIOS update image and storing the BIOS update image to a non-secure storage location accessible to the processor 130. At operation 204, the BIOS update tool may determine whether to read a status of a BIOS update of the processor 130. In some examples, the decision of whether or not to read the status of the BIOS update may be based on a timer, such that responsive to expiration of the timer (when the timer counts down) or a value of the timer reaching a threshold (when the timer counts up), the BIOS update tool may determine to read the status of the BIOS update. In other examples, the decision of whether or not to read the status of the BIOS update may be based on any suitable criteria or other operations. When the status of the BIOS update is to be read, the method may proceed to operation 206. When the status of the BIOS update is not to be read, the method 200 may proceed to operation 208.

At operation 206, the status of the BIOS update may be read. The status may be read, in some examples, by the BIOS update tool. In some examples, the status of the BIOS update may be read from a RAM of the controller 170. In some examples, an indicator visible to a user of the electronic device 100, such as a progress bar, percentage, or other graphical user interface element(s) may be updated based on the read status of the BIOS update to inform the user of the status of the BIOS update. After reading the status of the BIOS update, the method 200 may return to operation 202.

At operation 208, the BIOS update tool may generate an interrupt. In some examples, the interrupt may cause the processor 130 to transition from a current state of operation to a more trusted mode of operation, such as a system management mode (SMM) or other secure or semi-secure mode of operation, in which the processor 130 may obtain a portion of a BIOS update image. The portion of the BIOS update image may be obtained from a non-secure portion of a memory to which the BIOS update image was downloaded by the BIOS update tool. In some examples, the processor 130 may transfer the portion of the BIOS update image from the non-secure portion of the memory to a more secure portion of the memory, or another memory. The portion of the BIOS update image may have a size less than a size of an entirety of the BIOS update image. In some examples, each portion of the BIOS update image may have a size of about 4 kb or less. Subsequent to obtaining a portion of the BIOS update image, the method 200 may proceed to operation 210.

At operation 210, the processor 130 may determine whether the portion of the BIOS update image received at operation 208 is a last portion of the BIOS update image. Responsive to the portion of the BIOS update image received at operation 208 not being the last portion of the BIOS update image, the method 200 may return to operation 202. Responsive to the portion of the BIOS update image received at operation 208 being the last portion of the BIOS update image, the method 200 may proceed to operation 212.

At operation 212, the processor 130 may verify a signature of the BIOS update image. For example, the processor 130 may compare the signature of the BIOS update image to a value received by the electronic device 100 separate from the BIOS update image, to a programmed or expected value or key, or to any other suitable value. Responsive to determining that the signature of the BIOS update image is not verified (e.g., failure of the signature verification), the method 200 may return to operation 202. Responsive to determining that the signature of the BIOS update image is verified (e.g., success of the signature verification), the method 200 may proceed to operation 214.

At operation 214, a second interrupt may be generated. In some examples, the second interrupt may be generated by the BIOS update tool to again transition to the more trusted mode of operation, as described above. In other examples, the second interrupt may be generated by the controller 170. Responsive to generation of the second interrupt, at operation 216, the processor 130 may read the status of the BIOS update. Subsequent to reading the status of the BIOS update, the method 200 may proceed to both operation 218 and operation 220. At operation 216, the status of the BIOS update may be returned from the more trusted mode of operation or the controller 170 to the BIOS update tool, such as for further updating the progress bar or other indicator that indicates the status of the BIOS update.

At operation 220, a determination of a value of the status of the BIOS update may be determined. Responsive to determining that an error has occurred in updating the BIOS, the method 200 may proceed to operation 222. Similarly, responsive to determining that a threshold amount of the BIOS has been updated, the method 200 may proceed to operation 222. In some examples, the threshold amount may be 100%. In other examples, the threshold amount may be some amount other than 100%. Responsive to determining that an error has not occurred in updating the BIOS, and the threshold amount of the BIOS has not been updated, the method 200 may proceed to operation 224.

At operation 222, a notification may be generated and provided to the BIOS update tool. The notification, in some examples, may indicate that an error has occurred in updating the BIOS or that a threshold amount of the BIOS has been updated. In some examples, responsive to receipt of the notification, the BIOS update tool may proceed to operation 204.

At operation 224, the processor 130 may determine whether portions of the BIOS update image remain to be programmed. Responsive to determining that no portions of the BIOS update image remain to be programmed, the method 200 may proceed to operation 222. Responsive to determining that portions of the BIOS update image remain to be programmed, the method 200 may proceed to operation 226.

At operation 226, the processor 130 may provide a portion of the BIOS update image to the controller 170. In some examples, the processor 130 may provide the portion of the BIOS update image to the controller 170 by writing the portion of the BIOS update image to a shared memory interface, such as a shared portion of the memory module 150 accessible to both the processor 130 and the controller 170. The processor 130 may write the portion of the BIOS update to the shared portion of the memory module 150 from the more-secure memory location to which the processor 130 previously stored the portion of the BIOS update. In some examples, a size of the portion of the BIOS update image provided by the processor 130 to the controller 170 at operation 226 may be a same size as the size of the portions of the BIOS update image obtained at operation 208. In other examples, a size of the portion of the BIOS update image provided by the processor 130 to the controller 170 at operation 226 may be a different size than the size of the portions of the BIOS update image obtained at operation 208. After providing the portion of the BIOS update image to the controller 170, the method 200 may proceed to operation 228.

At operation 228, the controller 170 may program the portion of the BIOS update image obtained at operation 226. In some examples, the controller 170 may program the portion of the BIOS update image by writing the portion of the BIOS update image to the shared flash memory 180. After programming the portion of the BIOS update image, the method 200 may proceed to operation 230. At operation 230, the controller 170 may update the status of the BIOS update returns to operation 214.

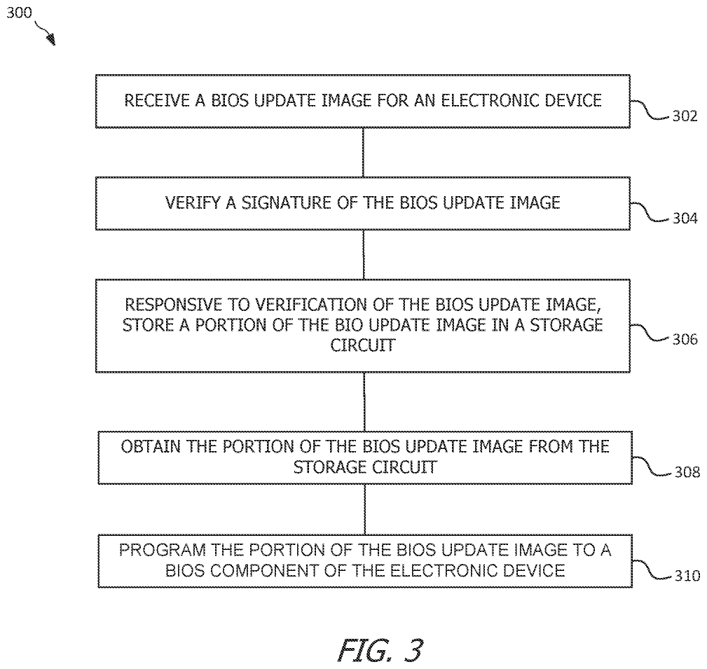

FIG. 3 is a flowchart of an example method 300 for BIOS updating. In some examples, the method 300 may be suitable for implementation on an electronic device, such as the electronic device 100 of FIG. 1. For example, in some implementations the method 300 may be partially embodied as the BIOS update executable computer program product 160 and may be performed in part by the processor 130 and in part by the controller 170. Accordingly, the method 300 may be implemented in part as computer-executable instructions or code, stored on a computer-readable medium, such as the memory module 150 of FIG. 1, which, when executed by a processor, such as the processor 130 of FIG. 1, may cause the processor 130 to execute the computer-executable instructions to perform operations. For example, the processor 130 may execute the computer-executable instructions to implement or execute a BIOS update tool. The method 300 may be implemented by the electronic device 100, in some examples, to update a BIOS of the processor 130.

At operation 302, a CPU may receive a BIOS update image for an electronic device. In some examples, the BIOS update images may be received in a plurality of portions, each having a size less than a total size of the BIOS update image, as further described elsewhere herein.

At operation 304, the CPU may verify a signature of the BIOS update image. In some examples, verification of the signature of the BIOS update images may verify whether the BIOS update image was accurately received. In some examples, the verifying may be by comparing a value obtained from the BIOS update image to a programmed value.

At operation 306, the CPU may store a portion of the BIOS update image in a storage circuit responsive to verification of the BIOS update image. In some examples, the portion of the BIOS update image may have a size less than a size of an entirety of the BIOS update image. The portion of the BIOS update image may be stored, for example, in a storage circuit accessible to both the CPU and a controller, as further described elsewhere herein.

At operation 308, the controller may obtain the portion of the BIOS update image from the storage circuit. The controller may obtain the portion of the BIOS update, in some examples, by reading the portion of the BIOS update from the storage circuit, as further described elsewhere herein.

At operation 310, the controller may program the portion of the BIOS update image to a BIOS component of the electronic device. In some examples, programming the portion of the BIOS update image may include writing the portion of the BIOS update image to a flash memory accessible to both the controller and the processor, as further described elsewhere herein.

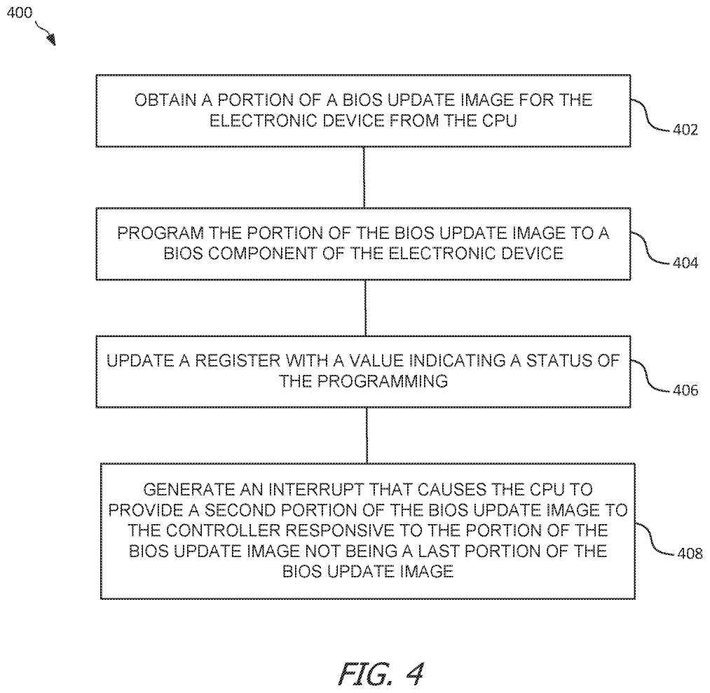

FIG. 4 is a flowchart of an example method 400 for BIOS updating. In some examples, the method 400 may be suitable for implementation on an electronic device, such as the electronic device 100 of FIG. 1. For example, in some implementations the method 400 may be implemented in part as computer-executable instructions or code, which, when executed by the controller 170 of FIG. 1, may cause the controller 170 to execute the computer-executable instructions to perform operations. For example, the controller 170 may execute the computer-executable instructions to update a BIOS of the processor 130.

At operation 402, the controller may obtain a portion of a BIOS update image for the electronic device. In some examples, the portion of the BIOS update image may be obtained from the processor, such as via a memory module. For example, the portion of the BIOS update image may be obtained from a shared portion of the memory module to which both the controller and the processor have access, and to which the processor wrote the portion of the BIOS update image, as further described elsewhere herein.

At operation 404, the controller may program the portion of the BIOS update image to a BIOS component of the electronic device. In some examples, programming the portion of the BIOS update image may include writing the portion of the BIOS update image to a flash memory accessible to both the controller and the processor, as further described elsewhere herein.

At operation 406, the controller may update a register with a value indicating a status of the programming. In some examples, the register may be stored in a non-volatile memory of the controller. The status may indicate, in some examples, a current percentage of the BIOS update image that has been programmed to the BIOS component of the electronic device.

At operation 408, the controller may generate an interrupt that may cause the processor to provide a second portion of the BIOS update image to the controller responsive to the portion of the BIOS update image not being a last portion of the BIOS update image, as further described elsewhere herein. In some examples, the processor may provide the second portion of the BIOS update image to the controller by writing the second portion of the BIOS update image to the shared portion of the memory module, as further described elsewhere herein.

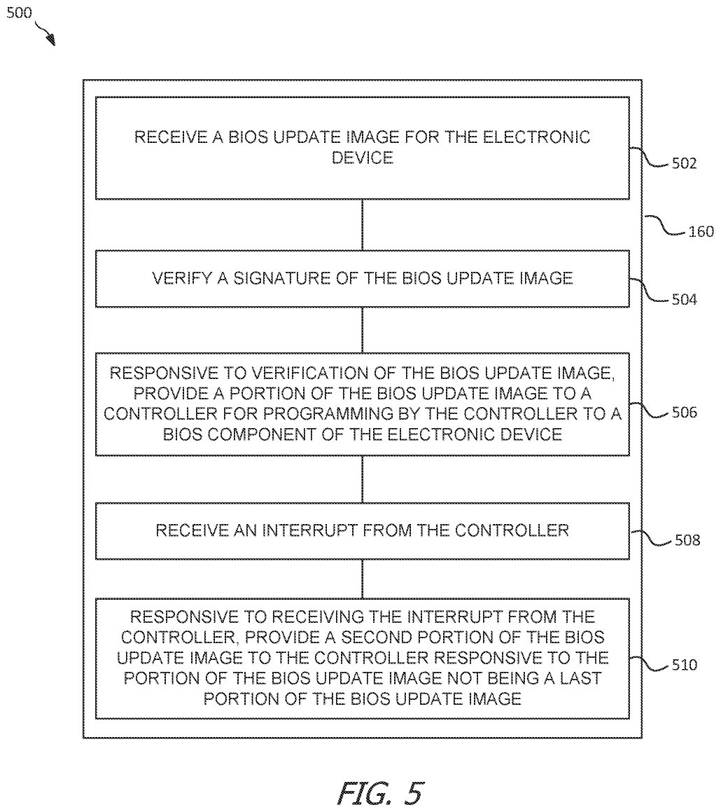

FIG. 5 is a flowchart of an example method 500 for BIOS updating. In some examples, the method 500 may be suitable for implementation on an electronic device, such as the electronic device 100 of FIG. 1. For example, in some implementations the method 500 may be partially embodied as the BIOS update executable computer program product 160 and may be performed in part by the processor 130 and in part by the controller 170. Accordingly, the method 500 may be implemented in part as computer-executable instructions or code, stored on a computer-readable medium, such as the memory module 150 of FIG. 1, which, when executed by a processor, such as the processor 130 of FIG. 1, may cause the processor 130 to execute the computer-executable instructions to perform operations. For example, the processor 130 may execute the computer-executable instructions to implement or execute a BIOS update tool. The method 500 may be implemented by the electronic device 100, in some examples, to update a BIOS of the processor 130.

At operation 502, the processor may receive a BIOS update image for the electronic device. In some examples, the BIOS update images may be received in a plurality of portions, each having a size less than a total size of the BIOS update image, as further described elsewhere herein.

At operation 504, the processor may verify a signature of the BIOS update image. In some examples, verification of the signature of the BIOS update images may verify whether the BIOS update image was accurately received. In some examples, the verifying may be by comparing a value obtained from the BIOS update image to a programmed value.

At operation 506, the processor, may provide a portion of the BIOS update image to the controller for programming by the controller to a BIOS component of the electronic device responsive to verification of the BIOS update image. In some examples, the portion of the BIOS update image may have a size less than a size of an entirety of the BIOS update image. The portion of the BIOS update image may be provided to the controller, for example, by the processor storing the portion of the BIOS update image in a storage circuit accessible to both the processor and the controller, such as a shared portion of the memory module, as further described elsewhere herein.

At operation 508, the processor may receive an interrupt from the controller. In some examples, receipt of the interrupt may indicate that the portion of the BIOS update image provided to the controller at operation 506 was successfully programmed to a BIOS component of the electronic device, such as the shared flash memory.

At operation 510, responsive to receiving the interrupt from the controller and if the portion of the BIOS update image was not a last portion of the BIOS update image, the processor may provide a second portion of the BIOS update image to the controller. In some examples, the processor may provide the second portion of the BIOS update image to the controller by writing the second portion of the BIOS update image to the shared portion of the memory module, as further described elsewhere herein.

The above discussion is meant to be illustrative of the principles and various examples of the present disclosure. Numerous variations and modifications are contemplated. It is intended that the following claims be interpreted to embrace all such variations and modifications.

What is claimed is:

1. An electronic device, comprising:
a storage circuit;
a central processing unit (CPU) coupled to the storage circuit, the CPU to:
receive a Basic Input/Output System (BIOS) update image for the electronic device;
verify a signature of the BIOS update image; and
responsive to verification of the BIOS update image, store a portion of the BIOS update image in the storage circuit; and
a controller coupled to the storage circuit, the controller to:
obtain the portion of the BIOS update image from the storage circuit; and
program the portion of the BIOS update image to a BIOS component of the electronic device.

2. The electronic device of claim 1, wherein the BIOS update image is in multiple portions, each 4 kilobytes in size or smaller.

3. The electronic device of claim 1, wherein the BIOS update image is in multiple portions and the controller is to store the BIOS update image to the storage circuit one portion at a time such that one portion of the multiple portions is present in the storage circuit at a given time.

4. The electronic device of claim 1, wherein the BIOS update image is a BIOS update for the CPU, and wherein the CPU is to perform processing unrelated to the BIOS update image while the controller programs the portion of the BIOS update image.

5. An electronic device, comprising:
a central processing unit (CPU); and
a controller, wherein the controller is to:
obtain a portion of a Basic Input/Output System (BIOS) update image for the electronic device from the CPU;
program the portion of the BIOS update image to a BIOS component of the electronic device;
update a register with a value indicating a status of the programming; and
generate an interrupt that causes the CPU to provide a second portion of the BIOS update image to the controller responsive to the portion of the BIOS update image not being a last portion of the BIOS update image.

6. The electronic device of claim 5, wherein the controller is to obtain the portion of the BIOS update image from a shared memory accessible to the CPU and the controller and to which the CPU wrote the portion of the BIOS update image.

7. The electronic device of claim 5, wherein the portion of the BIOS update image has a size of 4 kilobytes or less.

8. The electronic device of claim 5, wherein the BIOS component is a flash memory component having a serial peripheral interface shared between the BIOS component and the CPU.

9. The electronic device of claim 5, wherein the CPU is not interrupted from performing operations unrelated to the BIOS update image while the portion of the BIOS update image is programed to the BIOS component of the electronic device.

10. A non-transitory computer-readable medium storing executable code, which, when executed by a processor of an electronic device, causes the processor to:
receive a Basic Input/Output System (BIOS) update image for the electronic device;
verify a signature of the BIOS update image;
responsive to verification of the BIOS update image, provide a portion of the BIOS update image to a controller that programs the portion of the BIOS update image to a BIOS component of the electronic device;
receive an interrupt from the controller; and
responsive to receiving the interrupt from the controller, provide a second portion of the BIOS update image to the controller responsive to the portion of the BIOS update image not being a last portion of the BIOS update image.

11. The computer-readable medium of claim 10, wherein the instructions cause the processor to provide the portion of the BIOS update image to the controller by writing the portion of the BIOS update image to a shared memory accessible to both the processor and the controller.

12. The computer-readable medium of claim 11, wherein the BIOS update image includes multiple portions, including the portion of the BIOS update image, and the instructions cause the processor to provide write one of the multiple portions to the shared memory at a time.

13. The computer-readable medium of claim 10, wherein the interrupt indicates successful programming by the controller of the portion of the BIOS update image to the BIOS component of the electronic device.

14. The computer-readable medium of claim 10, wherein the processor is not interrupted from performing operations unrelated to the BIOS update image while the controller performs the programming of the portion of the BIOS image.

15. The computer-readable medium of claim 10, wherein the BIOS update image is a BIOS update for the processor, and wherein the instructions when executed cause the processor to perform processing unrelated to the processor update image while the controller programs the portion of the BIOS update image.
